(19) United States
(12) Patent Application Publication
(10) Pub. No.: US 2013/0295890 A1
(43) Pub. Date: Nov. 7, 2013

(54) TEXT FORWARDING APPARATUS AND METHOD

(71) Applicant: Electronics and Telecommunications Research Institute, (US)

(72) Inventors: Jaeyoung KIM, Daegu (KR); Kee Koo KWON, Daegu (KR); Gwang Su KIM, Daejeon (KR); Soo In LEE, Daejeon (KR)

(73) Assignee: Electronics and Telecommunications Research Institute, Daejeon (KR)

(21) Appl. No.: 13/804,985

(22) Filed: Mar. 14, 2013

(30) Foreign Application Priority Data
May 4, 2012 (KR) 10-2012-0047314

(51) Int. Cl. H04W 4/16

(52) U.S. Cl. CPC H04W 4/16
USPC 455/414.1

(57) ABSTRACT

Provided is a text forwarding apparatus and method that may format a received email to a form of a text message, and may forward the text message to a terminal corresponding to a phone number selected or directly input, the text forwarding apparatus including a controller to receive an input of a phone number of a terminal to which an email is to be forwarded when the email is received, and a processor to format contents of the email to a form of a text message, and to forward the text message to the terminal.

### CROSS-REFERENCE TO RELATED APPLICATION

This application claims the benefit of Korean Patent Application No. 10-2012-0047314, filed on May 4, 2012, in the Korean Intellectual Property Office, the disclosure of which is incorporated herein by reference.

### BACKGROUND

1. Field of the Invention

The present invention relates to a text forwarding apparatus and method that may format a received email to a form of a text message, and may forward the text message to a terminal corresponding to a phone number selected or input directly.

2. Description of the Related Art

With recent developments of a wireless communication environment, a mobile terminal is used for voice communications, and transmission and reception of multimedia files and emails, in contrast to earlier times. In addition, the proliferation of the Internet allows emails to be widely used for both private and public purposes. Accordingly, transmitting and receiving emails using a mobile terminal may maximize its effects.

In a conventional method, a mail server may forward a received email to a mail relay system using a virtual email account that is registered by a user in advance, and the mail relay system may forward the email to a registered mobile terminal through a mobile communication system.

According to the conventional method, since the email received by the mail server may be forwarded to the mobile terminal via the virtual email account, emails may be received without delay from a plurality of mail servers, irrespective of product types of the plurality of mail servers.

However, when a service subscriber generates and transmits an email, for example, a reply, and the like, to another mail server, using a mobile terminal, the email may be transmitted by the mail relay system in reality and thus, a virtual email account of a sender of the email may be recorded.

The virtual email account may correspond to an account generated to relay the email from the mail server to the mail relay system, and as such, it may not be easy for a receiver of the email to recognize the sender of the email.

In particular, when the mobile terminal receives the email transmitted to the receiver through a predetermined mail server, for example, an email account, by the conventional method described above, and a reply to the received email is transmitted through the mobile terminal, a virtual email account of the sender of the reply may be recorded and transmitted, as opposed to an email account of the mail server.

The conventional method may be inconvenient in that the user may need to read an email, and write and send a text message directly when the email is received, and the received email is to be forwarded in a form of the text message without delay.

### SUMMARY

An aspect of the present invention provides a text forwarding apparatus and method that may format a received email to a form of a text message, and may forward the formatted text message to a portable device corresponding to a phone number selected or input directly, thereby transferring information in a convenience manner when the email is not supported by a terminal or checking the email is impossible.

According to an aspect of the present invention, there is provided a text forwarding apparatus, including a controller to receive an input of a phone number of a terminal to which an email is to be forwarded when the email is received, and a processor to format contents of the email to a form of a text message, and to forward the text message to the terminal.

According to another aspect of the present invention, there is also provided a text forwarding method, including receiving an input of a phone number of a terminal to which an email is to be forwarded when the email is received, formatting contents of the email to be a form of a text message, and forwarding the text message to the terminal.

### Effect of the Invention

According to example embodiments of the present invention, by formatting a received email to a form of a text message, and forwarding the formatted text message to a portable device corresponding to a phone number selected or directly input, an amount of time required for writing a message to be forwarded may be reduced and information may be transferred in a convenience manner when the email is not supported by a terminal or checking the email is impossible.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating a configuration of a communication system according to an embodiment of the present invention;

FIG. 2 is a diagram illustrating categories of a text forwarding service according to an embodiment of the present invention;

FIG. 3 is a block diagram illustrating a configuration of a text forwarding apparatus according to an embodiment of the present invention; and

FIG. 4 is a flowchart illustrating a text forwarding method according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

Hereinafter, a text forwarding apparatus and method will be described with reference to the drawings according to example embodiments of the present invention.

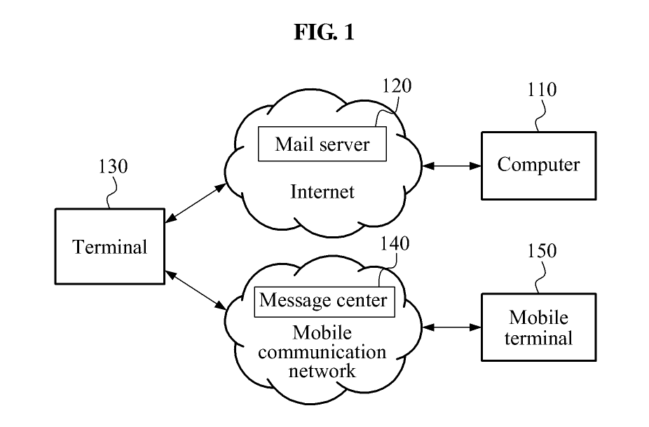

FIG. 1 is a diagram illustrating a configuration of a communication system according to an embodiment of the present invention.

A computer 110 may write an email, and forward the email to a terminal 130 corresponding to an email address, through a mail server 120.

The mail server 120 may receive the email from the computer 110 that may forward an email, and may forward the email to a destination terminal.

The terminal 130 may receive the email from the mail server 120, format contents included in the received email to a form of a text message, and forward, through a message center 140, the formatted text message to a mobile terminal 150 that may not receive an email.

The message center 140 may receive the text message, and may forward the text message to the mobile terminal 150 corresponding to the destination terminal.

The mobile terminal 150 may receive the text message from the message center 140, and may inform a user of the reception of the text message.

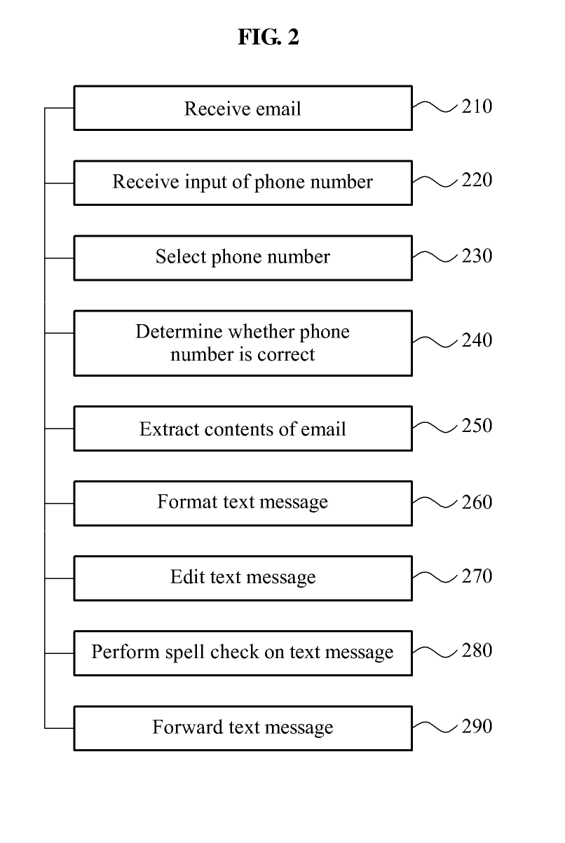

FIG. 2 is a diagram illustrating categories of a text forwarding service according to an embodiment of the present invention.

Receive Email 210

The terminal 130 may receive an email from the mail server 120. That is, the terminal 130 may receive the email corresponding to an email address of the terminal 130 from the mail server 120, based on a mail receiving protocol.

Receive Input of Phone Number 220

The terminal 130 may receive an input of a phone number of the mobile terminal 105 to which a text message formatted from contents included in the email is to be forwarded. The terminal 130 may provide a phone number input box so that a user may input a phone number.

Select Phone Number 230

The terminal 130 may display a list of phone numbers stored in an address book, and may select a phone number of the mobile terminal 150 that may receive the text message. The terminal 130 may select phone numbers of a plurality of mobile terminals 150.

Determine Whether Phone Number is Correct 240

The terminal 130 may determine whether the input phone number is correct, based on combinations of phone numbers that may be assigned to the mobile terminal 150. The terminal 130 may allow the text message to be forwarded, with respect to the correct phone number.

Extract Contents of Email 250

The terminal 130 may extract contents included in the email received from the mail server 120. The terminal 130 may extract the contents included in the email received from the mail server 120, based on the mail receiving protocol.

Format Text Message 260

The terminal 130 may format a text message, based on the contents extracted from the email. The terminal 130 may format the contents included in the email to a form of the text message, and store the formatted text message.

Edit Text Message 270

The terminal 130 may provide the user with a message editing interface so that the user may edit the text message. The terminal 130 may store the edited text message in a memory temporarily, and may wait for the text message to be forwarded.

Perform Spell Check on Message 280

The terminal 130 may perform a spell check by determining whether words included in the text are spelled correctly, by making reference to a dictionary database. The terminal 130 may wait for the text message on which the spell check is being performed to be forwarded.

Forward Text Message 290

The terminal 130 may forward the text message to the mobile terminal corresponding to the input phone number or the phone number selected from the list of phone numbers. The terminal 130 may forward the text message to the message center 140 so that the mobile terminal 150 corresponding to the phone number may receive the text message.

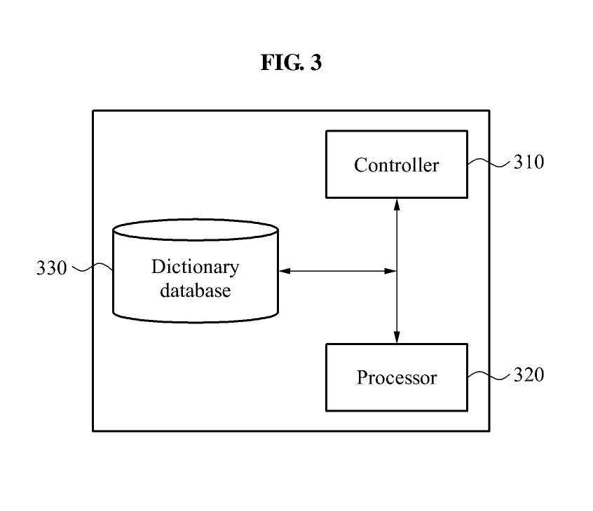

FIG. 3 is a block diagram illustrating a configuration of a text forwarding apparatus according to an embodiment of the present invention.

Referring to FIG. 3, the text forwarding apparatus may include a controller 310 to receive an input of a phone number of a mobile terminal to which an email is to be forwarded when the email is received, and a processor 320 to format contents of the email to a form of a text message, and to forward the text message to the mobile terminal.

The controller 310 may receive an input of a phone number of a mobile terminal to which an email is to be forwarded when the email is received. The controller 310 may display a list of phone numbers stored in an address book, and may receive an input of a phone number selected from the list of phone numbers. The controller 310 may determine whether the selected phone number corresponds to a correct number combination, and may receive an input of the selected phone number when the selected phone number corresponds to the correct number combination as a result of the determination.

The processor 320 may format contents of the email to a form of a text message, and may forward the text message to the mobile terminal. The processor 320 may format the text message by extracting the contents included in the email based on a mail receiving protocol corresponding to the email.

The processor 320 may provide an editing interface to edit the text message. The processor 320 may determine whether the formatted text message corresponds to a correct letter combination, based on a dictionary database 330 when the editing of the text message is completed, and may forward the text message when the formatted text message corresponds to the correct letter combination as a result of the determination.

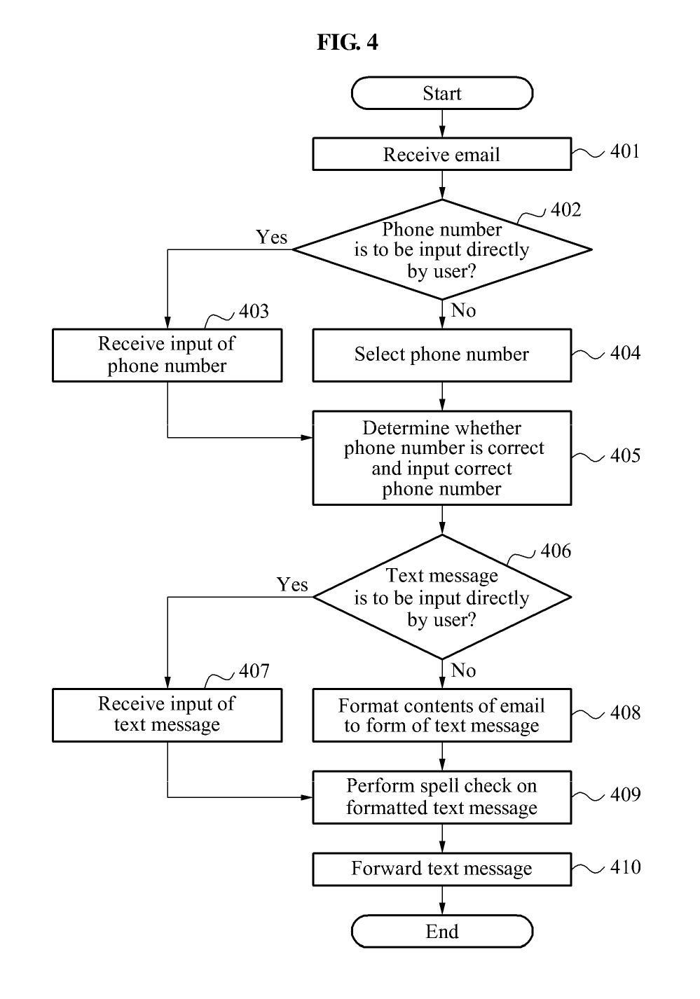

FIG. 4 is a flowchart illustrating a text forwarding method according to an embodiment of the present invention.

In operation 401, a terminal may receive an email from a mail server. The terminal may receive the email by accessing the mail server through a mail receiving protocol.

In operation 402, the terminal may provide a phone number input box, and may receive an input of a phone number directly from a user. In operation 430, the terminal may display a phone number input box, and may receive an input of a phone number when the email is received.

In operation 404, the terminal may display a list of phone numbers stored in an address book, and may receive an input of a phone number selected from the list of phone numbers.

In operation 405, the terminal may determine whether the input phone number is correct, and may receive an input of the correct phone number. The terminal may determine whether the input phone number corresponds to a correct number combination, and may receive an input of the correct phone number.

In operation 406, the terminal may display a text message input box, and may inquire as to whether a text message is to be input directly by the user. The terminal may receive an input of a text message by displaying the text message input box when the phone number is input.

In operation 407, the terminal may receive the text message from the user, by displaying a text input pad when the text message is determined be input by the user. The terminal may receive an input of the text message by receiving an input of a character string that is input through the text input pad.

In operation 408, the terminal may format the text message by extracting contents included in the email when the text message is determined to be formatted automatically. The terminal may format the text message by extracting the contents of the email, based on a format of the email.

In operation 409, the terminal may perform a spell check on words included in the text message, by making reference to a dictionary database.

In operation 410, the terminal may forward the correct text message for which the spell check is performed to a message center so that the mobile terminal may receive the text message. The mobile terminal may receive the text message from the message center, and may inform the user of the reception of the text message.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A text forwarding apparatus, comprising:
a controller to receive an input of a phone number of a terminal to which an email is to be forwarded when the email is received; and
a processor to format contents of the email to a form of a text message, and to forward the text message to the terminal.

2. The apparatus of claim 1, wherein the processor formats the text message by extracting the contents included in the email based on a mail receiving protocol corresponding to the email.

3. The apparatus of claim 1, wherein the controller displays a list of phone numbers stored in an address book, and receives an input of a phone number selected from the list of phone numbers.

4. The apparatus of claim 1, wherein the controller determines whether a selected phone number corresponds to a correct number combination, and receives an input of the selected phone number when the selected phone number corresponds to the correct number combination as a result of the determination.

5. The apparatus of claim 1, wherein the processor provides an editing interface to edit the text message.

6. The apparatus of claim 1, wherein the processor determines whether the formatted text message corresponds to a correct letter combination, based on a dictionary database, and forwards the text message when the formatted text message corresponds to the correct letter combination as a result of the determination.

7. A text forwarding method, comprising:
receiving an input of a phone number of a terminal to which an email is to be forwarded when the email is received;
formatting contents of the email to be a form of a text message; and
forwarding the text message to the terminal.

8. The method of claim 7, wherein the formatting comprises formatting the text message by extracting the contents included in the email based on a mail receiving protocol corresponding to the email.

9. The method of claim 7, wherein the receiving comprises displaying a list of phone numbers stored in an address book, and receiving an input of a phone number selected from the list of phone numbers.

10. The method of claim 7, wherein the receiving comprises determining whether a selected phone number corresponds to a correct number combination, and receiving an input of the selected phone number when the selected phone number corresponds to the correct number combination as a result of the determination.

11. The method of claim 7, wherein the formatting comprises providing an editing interface to edit the text message.

12. The method of claim 7, wherein the formatting comprises determining whether the formatted text message corresponds to a correct letter combination, based on a dictionary database, and forwarding the text message when the formatted text message corresponds to the correct letter combination as a result of the determination.
